(19) United States
(12) Patent Application Publication
(10) Pub. No.: US 2025/0385389 A1
(43) Pub. Date: Dec. 18, 2025

(54) SOLID-STATE BATTERY AND METHOD OF MANUFACTURING SOLID-STATE BATTERY

(71) Applicant: TOYOTA JIDOSHA KABUSHIKI KAISHA, Aichi-ken (JP)

(72) Inventors: Masashi CHIHARA, Nagoya-shi (JP); Takahiro TABUCHI, Toyota-shi (JP); Yuka YOKOI, Nagoya-shi (JP)

(21) Appl. No.: 19/227,481

(22) Filed: Jun. 4, 2025

(30) Foreign Application Priority Data
Jun. 18, 2024 (JP) 2024-098199

(51) Int. Cl. H01M 50/491; H01M 10/0585; H01M 10/42; H01M 50/403; H01M 50/54

(52) U.S. Cl. CPC H01M 50/491; H01M 10/0585; H01M 10/4235; H01M 50/403; H01M 50/54

(57) ABSTRACT

A solid-state battery of the present disclosure includes an electrode body and current collector tabs that are connected to the electrode body. The electrode body has a positive electrode current collector, a positive electrode active material layer, a solid electrolyte layer, a negative electrode active material layer, and a negative electrode current collector. The solid electrolyte layer has a support including a plurality of pores. The support has projecting parts that project relative to end surfaces of each of the positive electrode active material layer and the negative electrode active material layer. A number of pores in the support in the projecting parts is less than a number of pores in the support in the nonprojecting part.

### CROSS-REFERENCE TO RELATED APPLICATION

This application is based on and claims priority under 35 USC 119 from Japanese Patent Application No. 2024-098199 filed on Jun. 18, 2024, the disclosure of which is incorporated by reference herein.

### BACKGROUND

### Technical Field

The present disclosure relates to a solid-state battery and a method of manufacturing the solid-state battery.

### Related Art

Solid-state batteries are known as lithium-ion secondary batteries that excel in safety.

Japanese Patent Application Laid-open (JP-A) No. 2024-11688 discloses an all-solid-state battery (hereinafter also called “the solid-state battery”). The solid-state battery has an electrode body and current collector tabs that are connected to the electrode body. The electrode body has a first current collector, a first active material layer, a solid electrolyte layer, a second active material layer, and a second current collector. The electrode body has a first side surface portion, a second side surface portion that opposes the first side surface portion, and a third side surface portion that interjoins the first side surface portion and the second side surface portion. At the first side surface portion, the first active material layer, the solid electrolyte layer, and the second active material layer are flush. A protective member is disposed on the first side surface portion. The protective member covers a side surface of at least one of the first active material layer, the solid electrolyte layer, or the second active material layer. At the third side surface portion, the first active material layer, the solid electrolyte layer, and the second active material layer are flush. A specific lashing member is disposed on the third side surface portion. The lashing member covers a side surface of at least one of the first active material layer, the solid electrolyte layer, or the second active material layer. Resin is disclosed as the material of the protective member and the lashing member.

However, in the solid-state battery disclosed in JP-A No. 2024-11688, the material of the protective member and the lashing member and the materials of the electrode body are different kinds. In other words, the coefficient of thermal expansion of the protective member and the lashing member and the coefficient of thermal expansion of the electrode body are different. For that reason, when the solid-state battery is repeatedly charged and discharged, the adhesion of the protective member and the lashing member to the electrode body may weaken. If at least one of the protective member or the lashing member peels away from the electrode body, a short circuit between the positive electrode and the negative electrode of the electrode body may occur.

### SUMMARY

The present disclosure is in view of the above circumstances.

It is a problem to be solved by an embodiment of the present disclosure to provide a solid-state battery in which the occurrence of short circuits is inhibited and a method of manufacturing the solid-state battery.

Means for solving the above problem include the following aspects.

<1> A solid-state battery of a first aspect includes an electrode body and current collector tabs that are connected to the electrode body, wherein:
the electrode body has a positive electrode current collector, a positive electrode active material layer, a solid electrolyte layer, a negative electrode active material layer, and a negative electrode current collector that are laminated along a lamination direction,
the solid electrolyte layer has a support including a plurality of pores,
the support has projecting parts that project relative to end surfaces of each of the positive electrode active material layer and the negative electrode active material layer and a nonprojecting part that is not the projecting parts, and
a number of pores in the support in the projecting parts is less than a number of pores in the support in the nonprojecting part.

“Solid electrolyte layer” refers to a layer that includes a solid electrolyte but does not include an active material (i.e., at least one of a positive electrode active material or a negative electrode active material). “Positive electrode active material layer” refers to a layer that includes a positive electrode active material. “Negative electrode active material layer” refers to a layer that includes a negative electrode active material. “Support” refers to an insulator that has a plurality of pores, imparts mechanical strength to the solid electrolyte layer, and does not conduct electricity. “Pores in the support” refers to holes that have the solid electrolyte disposed inside them and hold the solid electrolyte. “Projecting parts” encompasses projecting parts that lack pores and are obtained by melting projecting parts that have pores. The projecting parts include the support but do not include the solid electrolyte. “The projecting parts do not include the solid electrolyte” refers to the volume of the solid electrolyte disposed in the projecting parts relative to the volume of the projecting parts being 10% or less, and it may be 0%. The laminate configuration of the “electrode body” includes a monopolar structure or a bipolar structure.

In the first aspect, the support has the projecting parts. The projecting parts block electrical contact between the positive electrode active material layer and the negative electrode active material layer. As a result, in the solid-state battery of the first aspect, the occurrence of short circuits is inhibited.

<2> A solid-state battery of a second aspect is the solid-state battery of <1>, wherein:
the electrode body includes a plurality of unit electrode bodies that are laminated along the lamination direction,
each unit electrode body includes the positive electrode current collector, the positive electrode active material layer, the solid electrolyte layer, the negative electrode active material layer, and the negative electrode current collector, and
projecting parts of solid electrolyte layers that are adjacent between two of the unit electrode bodies that are adjacent are interconnectedly disposed.

The laminate structure of the “unit electrode bodies” includes a monopolar structure or a bipolar structure.

In the second aspect, the projecting parts of the solid electrolyte layers that are adjacent between two of the unit electrode bodies that are adjacent are interconnectedly disposed. That is, at least one of the positive electrode active material layers or the negative electrode active material layers disposed between the solid electrolyte layers that are adjacent between two of the unit electrode bodies that are adjacent is easily reliably covered by the projecting parts. Because of this, the projecting parts more reliably block electrical contact between the positive electrode active material layers and the negative electrode active material layers. In addition, the projecting parts more reliably block electrical contact between the casing of the solid-state battery and at least one of the positive electrode active material layers or the negative electrode active material layers. As a result, in the solid-state battery of the second aspect, the occurrence of short circuits is further inhibited.

<3> A solid-state battery of a third aspect is the solid-state battery of <2>, wherein:
each unit electrode body is configured by laminating the positive electrode current collector, the positive electrode active material layer, the solid electrolyte layer, the negative electrode active material layer, the negative electrode current collector, the negative electrode active material layer, the solid electrolyte layer, the positive electrode active material layer, and the positive electrode current collector in this order along the lamination direction, and
the projecting parts are disposed interconnecting solid electrolyte layers that are adjacent within the unit electrode bodies.

In the third aspect, the laminate configuration of the electrode body is a configuration where a plurality of the unit electrode bodies having a monopolar structure are connected in parallel. In the third aspect, the projecting parts of the solid electrolyte layers that are adjacent within the unit electrode bodies are interconnected. That is, the positive electrode active material layers or the negative electrode active material layers disposed between the solid electrolyte layers that are adjacent within the unit electrode bodies are easily reliably covered by the projecting parts. Because of this, the projecting parts more reliably block electrical contact between the positive electrode active material layers and the negative electrode active material layers. In addition, the projecting parts more reliably block electrical contact between the casing of the solid-state battery and at least one of the positive electrode active material layers or the negative electrode active material layers. As a result, in the solid-state battery of the third aspect, the occurrence of short circuits is further inhibited.

<4> A solid-state battery of a fourth aspect is the solid-state battery of any one of <1> to <3>, wherein the projecting parts are disposed covering an end surface of at least one of the positive electrode active material layer or the negative electrode active material layer.

Because of this, the projecting parts more reliably block electrical contact between the positive electrode active material layer and the negative electrode active material layer. The projecting parts more reliably block electrical contact between the casing of the solid-state battery and at least one of the positive electrode active material layer or the negative electrode active material layer. As a result, in the solid-state battery of the fourth aspect, the occurrence of short circuits is further inhibited.

<5> A solid-state battery of a fifth aspect is the solid-state battery of any one of <1> to <4>, wherein:
the electrode body has:
   a first side surface portion,
   a second side surface portion that opposes the first side surface portion,
   a third side surface portion that interjoins the first side surface portion and the second side surface portion, and
   a fourth side surface portion that interjoins the first side surface portion and the second side surface portion and opposes the third side surface portion,
the current collector tabs project relative to at least one of the third side surface portion or the fourth side surface portion, and
the projecting parts are disposed covering the first side surface portion and the second side surface portion.

“Side surface portions of the electrode body” refers to surfaces of the electrode body whose normal direction intersects the normal direction (lamination direction) of a main surface of the electrode body. “Main surface” refers to a surface whose normal direction is parallel to the lamination direction. The “side surface portions of the electrode body” include the end surfaces of the positive electrode active material layer, the end surfaces of the nonprojecting part of the solid electrolyte layer, and the end surfaces of the negative electrode active material layer but do not include the projecting parts of the solid electrolyte layer. “Nonprojecting part of the solid electrolyte layer” refers to the part of the solid electrolyte layer that is not the projecting parts. The side surface portions of the electrode body may include at least one of the end surfaces of the positive electrode current collector or the end surfaces of the negative electrode current collector.

In the fifth aspect, the projecting parts are disposed covering the first side surface portion and the second side surface portion. Because of this, the projecting parts reliably block electrical contact between the positive electrode active material layer and the negative electrode active material layer more than in a case where the projecting parts are not disposed covering the first side surface portion and the second side surface portion. The projecting parts more reliably block electrical contact between the casing of the solid-state battery and at least one of the positive electrode active material layer or the negative electrode active material layer. As a result, in the solid-state battery of the fifth aspect, the occurrence of short circuits is further inhibited.

<6> A solid-state battery of a sixth aspect is the solid-state battery of any one of <1> to <5>, wherein:
the electrode body has:
   a first side surface portion,
   a second side surface portion that opposes the first side surface portion,
   a third side surface portion that interjoins the first side surface portion and the second side surface portion, and
   a fourth side surface portion that interjoins the first side surface portion and the second side surface portion and opposes the third side surface portion,
the current collector tabs project relative to at least one of the third side surface portion or the fourth side surface portion, and
the projecting parts are disposed connected to the current collector tabs at the third side surface portion and the fourth side surface portion.

“The projecting parts are disposed connected to the current collector tabs at the third side surface portion and the fourth side surface portion” refers to the projecting parts being in contact with the current collector tabs. For example, in a case where the projecting parts are projecting parts that have pores, the projecting parts may be in physical contact with the current collector tabs. For example, in a case where the projecting parts are projecting parts that does not have pores, the projecting parts may be stuck to the current collector tabs by melting the projecting parts.

In the sixth aspect, the projecting parts are disposed so as to be connected to the current collector tabs at the third side surface portion and the fourth side surface portion. That is, the positive electrode active material layer or the negative electrode active material layer disposed between the solid electrolyte layer and the current collector tabs is easily reliably covered by the projecting parts. Because of this, the projecting parts more reliably block electrical contact between the positive electrode active material layer and the negative electrode active material layer. The projecting parts more reliably block electrical contact between the casing of the solid-state battery and at least one of the positive electrode active material layer or the negative electrode active material layer. As a result, in the solid-state battery of the sixth aspect, the occurrence of short circuits is further inhibited.

<7> A solid-state battery of a seventh aspect is the solid-state battery of any one of <1> to <6>, wherein the support in the nonprojecting part comprises a nonwoven.

A “nonwoven” is a sheet-like structure made from fibers that are bonded or entangled without being woven and refers to a planar fiber assembly in which a predetermined level of structural strength is obtained by a physical method and/or chemical method excluding weaving, knitting, and papermaking (JIS L0222:2022). The fiber assembly has a plurality of pores. The nonwoven includes a resin.

The solid-state battery of the seventh aspect has a battery performance that is more sufficient than it is in a case where the support in the nonprojecting part does not comprise a nonwoven.

<8> A method of manufacturing a solid-state battery of an eighth aspect includes:
preparing a solid electrolyte sheet that has a support including a plurality of pores and a solid electrolyte that is not disposed in projecting parts representing peripheral edge parts of the support but is disposed in a part surrounded by the projecting parts of the support;
laminating a first current collector, a first active material layer, the solid electrolyte sheet, a second active material layer, and a second current collector along a lamination direction to form an electrode body having the projecting parts that project relative to end surfaces of the first active material layer and the second active material layer; and
inputting heat to the projecting parts of the electrode body in a direction from a side surface portion of the electrode body toward an inside of the electrode body to thereby melt the projecting parts at the side surface portion of the electrode body.

The solid-state battery manufacturing method of the eighth aspect can manufacture a solid-state battery in which the occurrence of short circuits is inhibited.

According to the embodiments of the present disclosure, a solid-state battery in which the occurrence of short circuits is inhibited and a method of manufacturing the solid-state battery are provided.

### BRIEF DESCRIPTION OF THE DRAWINGS

Exemplary embodiments of the present disclosure will be described in detail based on the following figures, wherein:

FIG. 1 is a perspective view of a solid-state battery pertaining to a first embodiment;

FIG. 2 is a front elevation view of an electrode body pertaining to the first embodiment;

FIG. 3 is a cross-sectional view taken along line III-III of FIG. 2;

FIG. 4 is a cross-sectional view taken along line IV-IV of FIG. 2;

FIG. 5 is a drawing for describing the method of manufacturing the solid-state battery of the first embodiment;

FIG. 6 is a drawing for describing the method of manufacturing the solid-state battery of the first embodiment;

FIG. 7 is a drawing for describing the method of manufacturing the solid-state battery of the first embodiment; and

FIG. 8 is a cross-sectional view of an example of an electrode body having a laminate configuration where a plurality of unit electrode bodies having a bipolar structure are connected in series.

### DETAILED DESCRIPTION

In the present disclosure, a numerical range expressed using “to” means a range that includes the numerical values appearing before and after the “to” as a minimum value and a maximum value, respectively. In numerical ranges that are progressively stated in the present disclosure, the upper limit value or the lower limit value stated in a given numerical range may be replaced with the upper limit value or the lower limit value of another progressively stated numerical range. In the present disclosure, a combination of two or more preferred aspects is a more preferred aspect. In the present disclosure, the term “step” includes not only an independent step but also a step that cannot be clearly distinguished from another step as long as the intended object of that step is achieved.

Embodiments of a solid-state battery and a method of manufacturing the solid-state battery of the present disclosure will now be described below with reference to the drawings. Regarding identical or corresponding parts in the drawings, identical reference signs are assigned thereto, and description thereof will not be repeated.

### (1) First Embodiment

### (1.1) Solid-State Battery

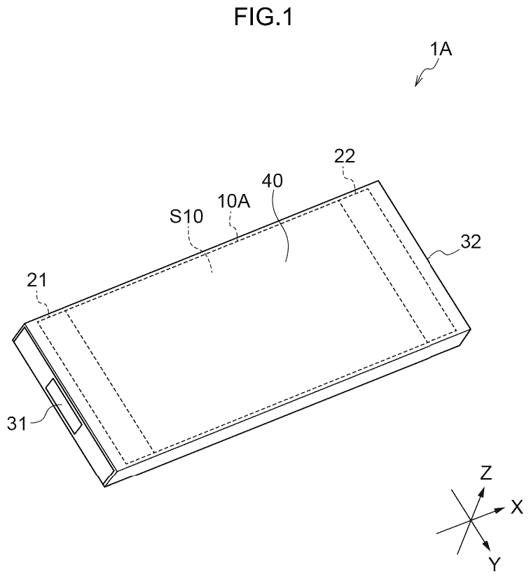

As shown in FIG. 1, a solid-state battery 1A pertaining to a first embodiment includes an electrode body 10A, a plurality of positive electrode current collector tabs 21 (an example of current collector tabs), a plurality of negative electrode current collector tabs 22 (an example of current collector tabs), a positive electrode terminal 31, a negative electrode terminal 32, and a casing 40. The electrode body 10A is a rectangular cuboid.

In the first embodiment, the lengthwise direction of a main surface S10 of the electrode body 10A defines the X-axis direction. The widthwise direction of the main surface S10 of the electrode body 10A defines the Y-axis direction. The thickness direction of the electrode body 10A defines the Z-axis direction. The X-axis, the Y-axis, and the Z-axis are all orthogonal to each other. The Z-axis direction is an example of a lamination direction. It will be noted that these directions are not intended to limit the directions of the solid-state battery of the present disclosure when it is in use.

The positive electrode terminal 31, the plural positive electrode current collector tabs 21, the electrode body 10A, the plural negative electrode current collector tabs 22, and the negative electrode terminal 32 are arranged in this order along the X-axis positive direction. The plural positive electrode current collector tabs 21 electrically interconnect the positive electrode terminal 31 and the electrode body 10A. The plural negative electrode current collector tabs 22 electrically interconnect the negative electrode terminal 32 and the electrode body 10A. The casing 40 covers the electrode body 10A, the plural positive electrode current collector tabs 21, and the plural negative electrode current collector tabs 22. The electrode body 10A, the positive electrode current collector tabs 21, and the negative electrode current collector tabs 22 are sealed by the positive electrode terminal 31, the negative electrode terminal 32, and the casing 40.

### (1.1.1) Electrode Body

The electrode body 10A functions as a power generating element of the solid-state battery 1A.

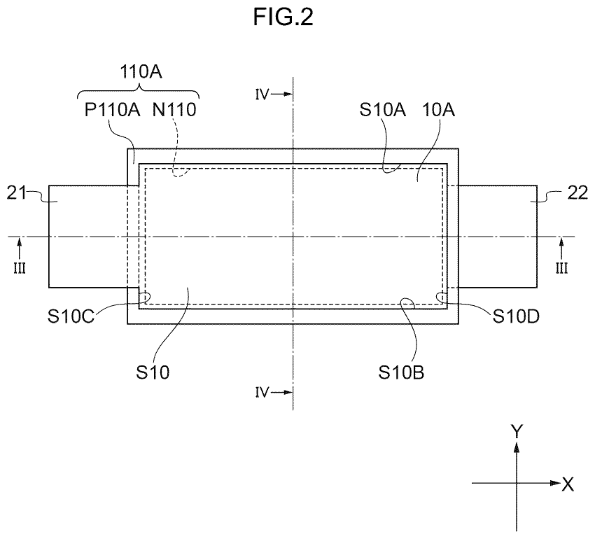

The electrode body 10A is a rectangular cuboid. As shown in FIG. 2, the electrode body 10A has a first side surface portion S10A, a second side surface portion S10B, a third side surface portion S10C, and a fourth side surface portion S10D. The second side surface portion S10B opposes the first side surface portion S10A in the Y-axis direction. The third side surface portion S10C interjoins the first side surface portion S10A and the second side surface portion S10B. The fourth side surface portion S10D interjoins the first side surface portion S10A and the second side surface portion S10B. The fourth side surface portion S10D opposes the third side surface portion S10C in the X-axis direction.

Each of the first side surface portion S10A, the second side surface portion S10B, the third side surface portion S10C, and the fourth side surface portion S10D may be a surface without steps (i.e., a flat surface) or a surface with steps (i.e., a stepped surface).

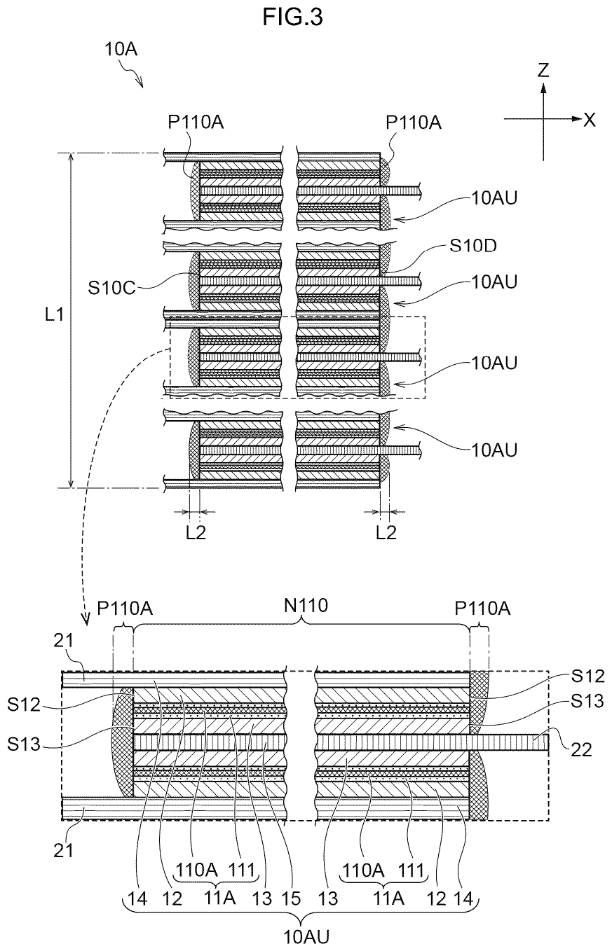

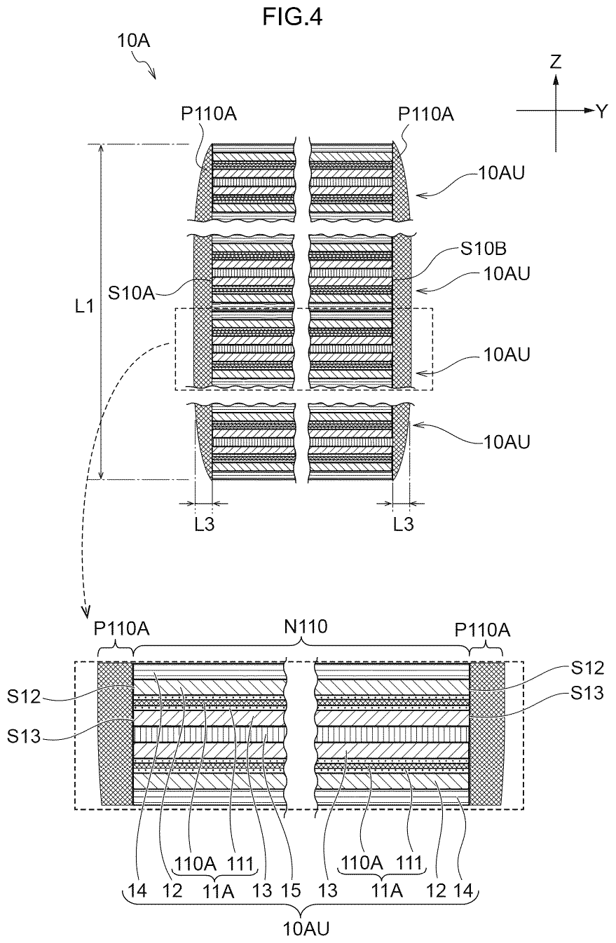

A length L1 (thickness) of the electrode body 10A in the Z-axis direction (see FIG. 3 and FIG. 4) is not particularly limited and may, for example, be 18.5 mm.

As shown in FIG. 3 and FIG. 4, the electrode body 10A includes a plurality of unit electrode bodies 10AU. The plural unit electrode bodies 10AU are laminated along the Z-axis direction. The plural unit electrode bodies 10AU are connected in parallel.

The laminate structure of the unit electrode bodies 10AU is a monopolar structure. Specifically, the unit electrode bodies 10AU each have two solid electrolyte layers 11A, two positive electrode active material layers 12, two negative electrode active material layers 13, two positive electrode current collectors 14, and one negative electrode current collector 15. The positive electrode current collector 14, the positive electrode active material layer 12, the solid electrolyte layer 11A, the negative electrode active material layer 13, the negative electrode current collector 15, the negative electrode active material layer 13, the solid electrolyte layer 11A, the positive electrode active material layer 12, and the positive electrode current collector 14 are laminated in this order along the Z-axis direction.

### (1.1.1.1) Solid Electrolyte Layers

Each of the solid electrolyte layers 11A includes a support 110A and a solid electrolyte 111. The solid electrolyte 111 is disposed in part of the support 110A. Specifically, the solid electrolyte 111 fills the inside of part of the support 110A. The solid electrolyte 111 covers part of the support 110A.

The supports 110A hold the solid electrolyte 111. The supports 110A and the solid electrolyte 111 prevent electrical contact between the positive electrode active material layers 12 and the negative electrode active material layers 13.

Each of the supports 110A has a projecting part P110A and a nonprojecting part N110. As shown in FIG. 3 and FIG. 4, the projecting parts P110A project relative to each of end surfaces S12 of the positive electrode active material layers 12 and end surfaces S13 of the negative electrode active material layers S13. The nonprojecting parts N110 are parts of the supports 110A that are not the projecting parts P110A. The nonprojecting parts N110 do not project relative to each of the end surfaces S12 of the positive electrode active material layers 12 and the end surfaces S13 of the negative electrode active material layers 13. The solid electrolyte 111 is not disposed in the projecting parts P110. The solid electrolyte 111 is disposed in the nonprojecting parts N110.

In the present disclosure, “the solid electrolyte is not disposed in the projecting parts” refers to the volume of the solid electrolyte disposed in the projecting parts relative to the volume of the projecting parts being 10% or less.

A number of pores in the supports 110A in the projecting parts P110A is less than a number of pores in the supports 110A in the nonprojecting parts N110. Specifically, in the first embodiment, the projecting parts P110A are parts obtained by melting the supports 110A, and the nonprojecting parts N110 are parts in which the supports 110A are not melted.

### (1.1.1.1.1) Projecting Parts

In the first embodiment, the projecting parts P110A are resin nonporous bodies. The supports 110A in the projecting parts P110A may or may not have pores. At the first side surface portion S10A (see FIG. 4) and the third side surface portion S10C (see FIG. 3), the projecting parts P110A of the solid electrolyte layers 11A that are adjacent within the unit electrode bodies 10AU are melted and integrated. At the second side surface portion S10B (see FIG. 4) and the fourth side surface portion S10D (see FIG. 3), the projecting parts P110A of the solid electrolyte layers 11A that are adjacent between two of the unit electrode bodies 10AU that are adjacent are melted and integrated. In the first embodiment, the plural projecting parts P110A configure a film-like object.

As shown in FIG. 3 and FIG. 4, the projecting parts P110A are disposed so as to cover the entire surfaces of each of the first side surface portion S10A, the second side surface portion S10B, the third side surface portion S10C, and the fourth side surface portion S10D of the electrode body 10A. As shown in FIG. 3, the projecting parts P110A are disposed so as to be connected to the positive electrode current collector tabs 21 and the negative electrode current collector tabs 22 at the third side surface portion S10C and the fourth side surface portion S10D. The projecting parts P110A are in contact with the positive electrode current collector tabs 21 and the negative electrode current collector tabs 22.

The projecting parts P110A may or may not be in contact with at least parts of each of the first side surface portion S10A, the second side surface portion S10B, the third side surface portion S10C, or the fourth side surface portion S10D of the electrode body 10A.

A maximum length L2 (maximum thickness) of the projecting parts P110A in the X-axis direction at the third side surface portion S10C and the fourth side surface portion S10D (see FIG. 3) is not particularly limited and may be 0.05 mm to 0.20 mm. A maximum length L3 (maximum thickness) of the projecting parts P110A in the Y-axis direction at the first side surface portion S10A and the second side surface portion S10B (see FIG. 4) is not particularly limited and may be 0.2 mm to 1.0 mm.

The material of the projecting parts P110A is the same as the material of the nonprojecting parts N110 described later.

### (1.1.1.1.2) Nonprojecting Parts

The nonprojecting parts N110 are resin porous bodies. The supports 110A in the nonprojecting parts N110 have a plurality of pores.

The pore size of the supports 110A in the nonprojecting parts N110 is not particularly limited and may, from standpoints such as further reducing the battery resistance of the solid-state battery 1A, be 1 μm to 15 μm. The method of measuring the pore size of the supports 110A in the nonprojecting parts N110 is the bubble point method (JIS K 3832).

The areal weight of the supports 110A in the nonprojecting parts N110 is not particularly limited and may, from standpoints such as further reducing the battery resistance of the solid-state battery 1A, be 0.10 mg/cm² to 0.80 mg/cm². The areal weight of the supports 110A in the nonprojecting parts N110 is obtained by cutting out sheets with a certain area from the nonprojecting parts N110 and calculating the mass per unit area of the sheets that have been cut out.

The void fraction of the supports 110A in the nonprojecting parts N110 is not particularly limited and may, from standpoints such as further reducing the battery resistance of the solid-state battery 1A, be 30% to 95% or 30% to 70%. “Void fraction” refers to the volume of the voids inside the supports 110A in the nonprojecting parts N110 relative to the total volume of the supports 110A in the nonprojecting parts N110. The void fraction of the supports 110A in the nonprojecting parts N110 is obtained by calculating the volume of the voids from the difference between the actual volume of the supports 110A in the nonprojecting parts N110 and the volume calculated from the specific gravity of the material and calculating the ratio of the voids to the actual volume of the supports 110A in the nonprojecting parts N110.

The length (thickness) of the nonprojecting parts N110 in the Z-axis direction is not particularly limited and may be 10 μm to 30 μm or 10 μm to 15 μm. The thickness of the nonprojecting parts N110 is measured using a bench micrometer.

Examples of the nonprojecting parts N110 include nonwovens, porous films, or mesh sheets. The nonprojecting parts N110 are preferably a nonwoven.

“Porous films” refers to resin films that do not include resin fibers and have a plurality of pores. “Mesh sheets” refers to woven fabrics that include a plurality of resin fibers and have pores between the resin fibers.

The nonwoven is not particularly limited, and examples thereof include meltblown nonwovens, spunbond nonwovens, carded nonwovens, parallel-laid nonwovens, cross-laid nonwovens, random-laid nonwovens, spunlaid nonwovens, flashspun nonwovens, chemical bonded nonwovens, hydroentangled nonwovens, needle-punched nonwovens, stitch-bonded nonwovens, thermobonded nonwovens, burst fiber nonwovens, tow opening nonwovens, and film-split nonwovens.

Among these, the type of the nonwoven is preferably a meltblown nonwoven. A meltblown nonwoven comprises ultrafine fibers (e.g., fibers having a diameter of 1 μm to 6 μm). For that reason, with a meltblown nonwoven, even if its areal weight is low the number of fibers included in the nonwoven is high. As a result, a nonwoven in which the pore size, the areal weight, and the void fraction are within the above-described ranges is easily obtained.

The nonwoven is configured by fibers. The fiber diameter and the fiber length of the fibers are not particularly limited. The fibers may be filament fibers or staple fibers. The cross-sectional shape of the fibers is not particularly limited, and examples thereof include a circular shape, an oval shape, or an irregular shape.

Examples of materials of the fibers include resins and glass. Examples of the resins include polyester resins (e.g., polyethylene terephthalate (PET)), polyolefin resins (e.g., polyethylene (PE) or polypropylene (PP)), or polyamide resins (e.g., nylon or aramids).

Examples of materials of the porous films include polyolefin resins (e.g., polyethylene (PE) or polypropylene (PP)).

The mesh sheets are configured by fibers. Examples of the fibers of the mesh sheets include the same ones as those that were exemplified as fibers of the nonwovens.

### (1.1.1.1.3) Solid Electrolyte

The solid electrolyte 111 is not particularly limited and may be an aggregate of a plurality of particles. The particle size of the particles is not particularly limited as long as it is a particle size that can penetrate the insides of the pores in the supports 110A in the nonprojecting parts N110 and may be 0.05 μm to 3.0 μm. The particle size of the particles is preferably smaller than the thickness of the nonprojecting parts N110. The ratio of the total volume of the solid electrolyte 111 to the total volume of the voids in the supports 110A in the nonprojecting parts N110 may be 50 vol % or more, 70 vol % or more, or 90 vol %. The particle size of the particles is obtained by observing the cross-sections of the solid electrolyte layers 11A with a scanning electron microscope (SEM), randomly selecting particles, and measuring the average value of the particle sizes.

The solid electrolyte 111 preferably includes one selected from the group comprising sulfide solid electrolytes, oxide solid electrolytes, and halide solid electrolytes. The solid electrolyte 111 may be a known solid electrolyte.

### (1.1.1.1.4) Binder

The solid electrolyte layers may further include a binder. The binder may be used for binding together the solid electrolyte. The binder may be used for binding the solid electrolyte 111 and the positive electrode active material layers 12 or the negative electrode active material layers 13. Examples of the binder include vinyl halide resins (e.g., polyvinylidene fluoride (PVdF)), rubbers (e.g., acrylate-butadiene rubber (ABR) or styrene-butadiene rubber (SBR)), or polyolefin resins (e.g., polyethylene (PE) or polypropylene (PP)).

### (1.1.1.2) Positive Electrode Active Material Layers

The positive electrode active material layers 12 contain a positive electrode active material. The positive electrode active material layers 12 may contain at least one of a solid electrolyte for a positive electrode, a conductive additive, or a binder as needed.

The positive electrode active material layers 12 preferably include a lithium complex oxide as the positive electrode active material. The lithium complex oxide may contain at least one type selected from the group comprising F, Cl, N, S, Br, or I. Furthermore, the lithium complex oxide may have a crystalline structure belonging to at least one space group selected from the space groups R-3m, Immm, or P63-mmc. Furthermore, the main array of the transition metal, oxygen, and lithium in the lithium complex oxide may have an O2 structure. The positive electrode active material may be a known positive electrode active material.

Examples of the solid electrolyte for a positive electrode that can be used in the positive electrode active material layers include the same ones as those that were exemplified as the solid electrolyte included in the solid electrolyte layers.

Examples of the conductive additive include carbon materials (e.g., carbon black, carbon nanotubes, graphite, or carbon fluoride), metal materials (e.g., aluminum powder or conductive whiskers), or conductive polymer materials (e.g., polyaniline, polypyrrole, or polythiophene).

Examples of the binder include the same ones as those that were exemplified as binders included in the solid electrolyte layers.

### (1.1.1.3) Negative Electrode Active Material Layers

The negative electrode active material layers 13 contain a negative electrode active material. The negative electrode active material layers 13 may contain at least one of a solid electrolyte for a negative electrode, a conductive additive, or a binder as needed.

Examples of the negative electrode active material include Li-based active materials (e.g., metallic lithium), carbon-based active materials (e.g., graphite), oxide-based active materials (e.g., lithium titanate), or Si-based active materials (e.g., elemental Si).

Examples of the solid electrolyte for a negative electrode include the same ones as those that were exemplified as solid electrolytes for a positive electrode that can be used in the positive electrode active material layers.

Examples of conductive additives that can be used in the negative electrode active material layers include the same ones as those that were exemplified as conductive additives that can be used in the positive electrode active material layers.

Examples of binders that can be used in the negative electrode active material layers include the same ones that were exemplified as binders that can be used in the positive electrode active material layers.

### (1.1.1.4) Positive Electrode Current Collectors

The positive electrode current collectors 14 collect current from the positive electrode active material layers 12. The material of the positive electrode current collectors is not particularly limited, and examples thereof include stainless steel, aluminum, copper, nickel, iron, titanium, or carbon. The positive electrode current collectors may be aluminum alloy foil or aluminum foil. The aluminum alloy foil and the aluminum foil may be manufactured using powder. The shape of the positive electrode current collectors may be foil-like or mesh-like. The positive electrode current collectors may have a configuration where a buffer layer, an elastic layer, or a positive temperature coefficient (PTC) thermistor layer is disposed on their surfaces.

### (1.1.1.5) Negative Electrode Current Collector

The negative electrode current collector 15 collects current from the negative electrode active material layers 13. The material of the negative electrode current collector is not particularly limited, and examples thereof include stainless steel, aluminum, copper, nickel, iron, titanium, or carbon. The negative electrode current collector may be copper foil. The shape of the negative electrode current collector may be foil-like or mesh-like. The negative electrode current collector may have a configuration where a buffer layer, an elastic layer, or a positive temperature coefficient (PTC) thermistor layer is disposed on its surface.

### (1.1.2) Positive Electrode Current Collector Tabs and Negative Electrode Current Collector Tabs

The positive electrode current collector tabs 21 electrically interconnect the positive electrode current collectors 14 and the positive electrode terminal 31. The positive electrode current collector tabs 21 are connected to the positive electrode current collectors 14. As shown in FIG. 2 and FIG. 3, the positive electrode current collector tabs 21 project in the X-axis negative direction relative to the third side surface portion S10C. Specifically, in the first embodiment, a bundle including the plural positive electrode current collector tabs 21 is electrically connected to the positive electrode terminal 31. The positive electrode current collector tabs 21 are preferably formed continuously from the positive electrode current collectors 14.

The negative electrode current collector tabs 22 electrically interconnect the negative electrode current collectors 15 and the negative electrode terminal 32. The negative electrode current collector tabs 22 are connected to the negative electrode current collectors 15. As shown in FIG. 2 and FIG. 3, the negative electrode current collector tabs 22 project in the X-axis positive direction relative to the fourth side surface portion S10D. Specifically, in the first embodiment, a bundle including the plural negative electrode current collector tabs 22 is electrically connected to the negative electrode terminal 32. The negative electrode current collector tabs 22 are preferably formed continuously from the negative electrode current collectors 15.

The material of the negative electrode current collector tabs and the positive electrode current collector tabs is not particularly limited and may be metal (e.g., aluminum, stainless steel (SUS), or nickel).

### (1.1.3) Negative Electrode Terminal and Positive Electrode Terminal

The positive electrode terminal 31 and the negative electrode terminal 32 are used to conduct electricity generated by the electrode body to the outside of the solid-state battery 1A. The positive electrode terminal 31 and the negative electrode terminal 32 are rectangular cuboids. Examples of the material of the positive electrode terminal 31 and the negative electrode terminal 32 include metal (e.g., aluminum, stainless steel (SUS), or nickel).

### (1.1.4) Casing

The casing 40 covers the electrode body 10A and, together with the positive electrode terminal 31 and the negative electrode terminal 32, seals the electrode body 10A. In the first embodiment, the casing 40 is a metal container. The casing 40 is a rectangular cuboid (i.e., prismatic). The casing 40 has a first wall that opposes the third side surface portion S10C of the electrode body 10A and a second wall that opposes the fourth side surface portion S10D of the electrode body 10A. The first wall has one through hole. As shown in FIG. 1, the positive electrode terminal 31 is exposed through the through hole in the first wall. The second wall has one through hole that is the same as the one in the first wall. The negative electrode terminal 32 is exposed through the through hole in the second wall. The material of the casing 40 is metal (e.g., aluminum, copper, stainless steel (SUS), or nickel). The casing 40 may have an electrical insulator on the surfaces (inner peripheral walls) that oppose the electrode body 10A to prevent electrical connection with the electrode body 10A. The electrical insulator may be a layer-like object or a bag.

### (1.1.5) Applications

Examples of applications of the solid-state battery 1A include being a power source for electrical devices (e.g., vehicles, electronic devices, or electricity storages). Examples of vehicles include four-wheeled electric vehicles, two-wheeled electric vehicles, gasoline automobiles, or diesel automobiles. Examples of four-wheeled electric vehicles include battery electric vehicles (BEV), plug-in hybrid electric vehicles (PHEV), or hybrid electric vehicles (HEV). Examples of two-wheeled electric vehicles include electric bikes or pedal-assist electric bicycles. Examples of electronic devices include handheld devices (e.g., smartphones, tablet computers, or audio players), portable devices (e.g., notebook computers or compact disc (CD) players), or movable devices (e.g., electric tools or professional video cameras). Among these, the solid-state battery 1A is preferably applied as a power source for driving a hybrid electric vehicle, a plug-in hybrid electric vehicle, or a battery electric vehicle.

### (1.2) Solid-State Battery Manufacturing Method

The solid-state battery manufacturing method of the first embodiment is a method of manufacturing the solid-state battery 1A. The manufacturing method includes a preparation step, a unit electrode body formation step, a first heating step, a lamination step, a second heating step, a connection step, and a sealing step. The preparation step, the unit electrode body formation step, the first heating step, the lamination step, the second heating step, the connection step, and the sealing step are carried out in this order.

### (1.2.1) Preparation Step

In the preparation step, solid electrolyte sheets 11S are prepared.

The solid electrolyte sheets 11S are the raw material of the solid electrolyte layers 11A. Each of the solid electrolyte sheets 11S has a support 110B including a plurality of pores and the solid electrolyte 111. The solid electrolyte 111 is not disposed in projecting parts P110B representing the peripheral edge parts of the supports 110B but are disposed in parts (i.e., parts corresponding to the nonprojecting parts N110) (hereinafter also called “central parts”) surrounded by the projecting parts P110B of the supports 110B. The supports 110B are sheet-like objects. The supports 110B are the same as the supports 110A except that their projecting parts include a plurality of pores. In other words, the projecting parts P110B of the solid electrolyte sheets 11S, in contrast to the projecting parts P110A, lack a history of the resin porous bodies being melted.

The method of preparing the solid electrolyte sheets 11S is not particularly limited, and examples thereof include a method in which a solid electrolyte paste is applied to the central parts of the supports 110B and dried. The solid electrolyte paste includes the solid electrolyte 111 and a known dispersion medium and may include a binder as needed. The application method and the drying method may be any known methods.

### Unit Electrode Body Formation Step

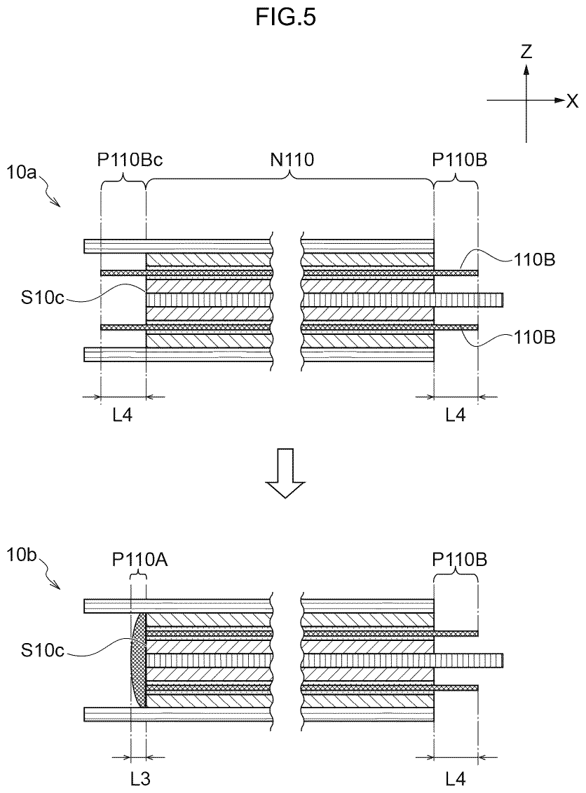

In the unit electrode body formation step, the positive electrode current collector 14 with the positive electrode current collector tab 21, the positive electrode active material layer 12, the solid electrolyte sheet 11S, the negative electrode active material layer 13, the negative electrode current collector 15 with the negative electrode current collector tab 22, the negative electrode active material layer 13, the solid electrolyte sheet 11S, the positive electrode active material layer 12, and the positive electrode current collector 14 with the positive electrode current collector tab 21 are laminated in this order along the Z-axis direction to form a unit electrode body 10a (see FIG. 5). The unit electrode body 10a has the projecting parts P110B. The projecting parts P110B project relative to each of the end surfaces S12 of the positive electrode active material layers 12 and the end surfaces S13 of the negative electrode active material layers 13. It will be noted that in FIG. 5 some of the projecting parts P110B are labeled as projecting parts P110Bc.

The unit electrode body 10a is the same as the unit electrode body 10AU except that the projecting parts P110A are changed to the projecting parts P110B.

The method of forming the positive electrode current collectors 14 with the positive electrode current collector tabs 21, the positive electrode active material layers 12, the negative electrode active material layers 13, and the negative electrode current collector 15 with the negative electrode current collector tab 22 is not particularly limited and may be any known method. The lamination method is not particularly limited and may be any known method.

A length L4 of the projecting parts P110B in the X-axis direction (see FIG. 5) is not particularly limited and may be 0.5 mm to 7.0 mm.

Hereinafter, the side surface portion of the unit electrode body 10a corresponding to the third side surface portion S10C of the electrode body 10A will also be called “S10c”. The projecting parts P110B that project relative to the third side surface portion S10c of the unit electrode body 10a will also be called “P110Bc”.

### (1.2.4) First Heating Step

In the first heating step, heat is input to the projecting parts P110Bc of the unit electrode body 10a in a direction from the third side surface portion S10c of the unit electrode body 10a toward the inside of the unit electrode body 10a to thereby melt the projecting parts P110Bc at the third side surface portion S10c of the unit electrode body 10a. This turns the projecting parts P110Bc into the projecting part P110A. A unit electrode body 10b (see FIG. 5) is obtained.

The heat input method is not particularly limited, and examples thereof include using a heat gun or an infrared lamp. The melting point of the supports 110B is preferably 100° C. to 150° C.

### (1.2.5) Lamination Step

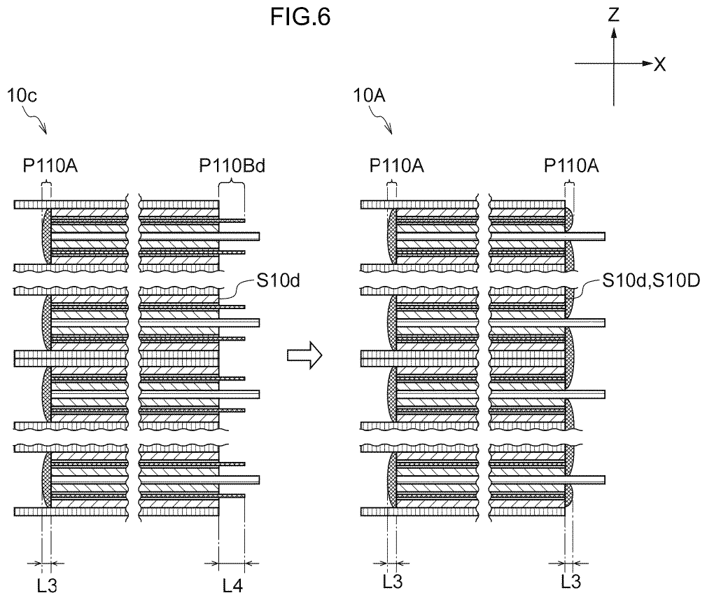

In the lamination step, a plurality of the unit electrode bodies 10b are laminated along the Z-axis direction to form an electrode body 10c (see FIG. 6). The electrode body 10c is the same as the electrode body 10A except that the projecting parts P110B have a plurality of pores. The electrode body 10c has a plurality of the projecting parts P110A. The projecting parts P110A of the electrode body 10c project relative to each of the end surfaces S12 of the positive electrode active material layers 12 and the end surfaces S13 of the negative electrode active material layers 13.

The lamination method is not particularly limited and may be any known method.

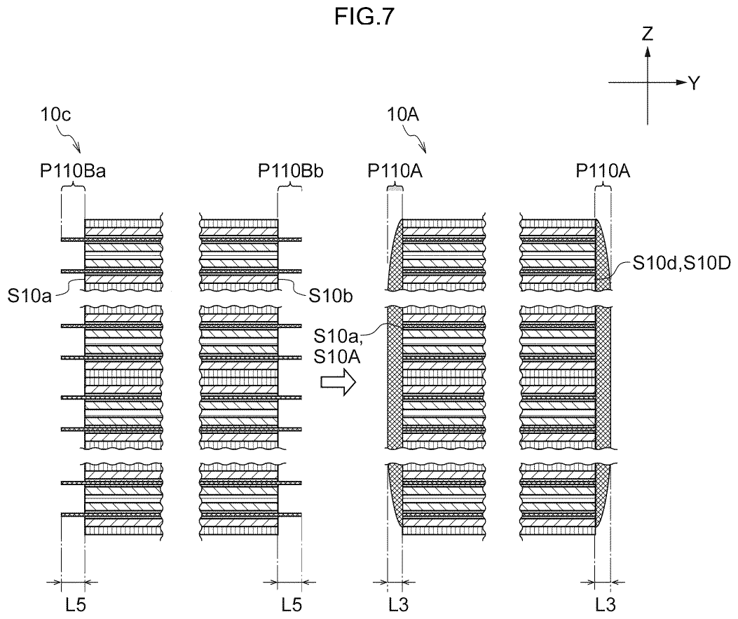

A length L5 of the projecting parts P110B of the electrode body 10c in the Y-axis direction (see FIG. 7) is not particularly limited and may be 2.0 mm to 7.0 mm. It will be noted that in FIG. 7 the projecting parts P110B are labeled as projecting parts P110Ba and projecting parts P110Bb.

Hereinafter, the side surface portion of the unit electrode bodies 10b corresponding to the first side surface portion S10A of the electrode body 10A will also be called “S10a”. The side surface portion of the unit electrode bodies 10b corresponding to the second side surface portion S10B of the electrode body 10A will also be called “S10b”. The side surface portion of the unit electrode bodies 10b corresponding to the fourth side surface portion S10D of the electrode body 10A will also be called “S10d”. The projecting parts P110B that project relative to the first side surface portion S10a of the unit electrode bodies 10b will also be called “P110Ba”. The projecting parts P110B that project relative to the second side surface portion S10b of the unit electrode bodies 10b will also be called “P110Bb”. The projecting parts P110B that project relative to the fourth side surface portion S10d of the unit electrode bodies 10b will also be called “P110Bd”.

### (1.2.6) Second Heating Step

In the second heating step, heat is input to the projecting parts P110Ba, P110Bb, P110Bd of the electrode body 10c in directions from the side surface portions S10a, S10b, S10d of the electrode body 10c toward the inside of the electrode body 10c to thereby melt the projecting parts P110Ba, P110Bb, P110Bd at the side surface portions S10a, S10b, S10d of the electrode body 10c. This turns the projecting parts P110Ba, P110Bb, P110Bd into the projecting parts P110A. The electrode body 10A (see FIG. 6 and FIG. 7) is obtained.

The heat input method is not particularly limited, and examples thereof include the same ones as those that were exemplified as heat input methods in the first heating step.

### (1.2.7) Connection Step

In the connection step, the plurality of positive electrode current collector tabs 21 connected to the electrode body 10A are connected to the positive electrode terminal 31, and the plurality of negative electrode current collector tabs 22 connected to the electrode body 10A are connected to the negative electrode terminal 32. Specifically, in the first embodiment, a first bundle including the plurality of positive electrode current collector tabs 21 is formed, and the first bundle is electrically connected to the positive electrode terminal 31. Likewise, a second bundle including the plurality of negative electrode current collector tabs 22 is formed, and the second bundle is electrically connected to the negative electrode terminal 32.

The connection method is not particularly limited and may be any known method.

### (1.2.8) Sealing Step

In the sealing step, the electrode body 10A to which the positive electrode terminal 31 and the negative electrode terminal 32 have been connected is sealed in the casing 40. Because of this, the solid-state battery 1A is obtained.

The sealing method is not particularly limited and may be any known method.

### (1.3) Action and Effects

The action and effects of the solid-state battery 1A will now be specifically described below with reference to the drawings.

As has been described with reference to FIG. 1 to FIG. 7, the solid-state battery 1A includes the electrode body 10A, the positive electrode current collector tabs 21, and the negative electrode current collector tabs 22. The electrode body 10A has the positive electrode current collectors 14, the positive electrode active material layers 12, the solid electrolyte layers 11A, the negative electrode active material layers 13, and the negative electrode current collectors 15 that are laminated along the Z-axis direction. The solid electrolyte layers 11A have the supports 110A. The supports 110A have the projecting parts P110A and the nonprojecting parts N110. A number of pores in the supports 110A in the projecting parts P110A is less than a number of pores in the supports 110A in the nonprojecting parts N110.

The projecting parts P110A block electrical contact between the positive electrode active material layers 12 and the negative electrode active material layers 13. As a result, in the solid-state battery 1A, the occurrence of short circuits is inhibited.

As has been described with reference to FIG. 1 to FIG. 7, the electrode body 10A includes a plurality of the unit electrode bodies 10AU that are laminated along the Z-axis direction. Each of the unit electrode bodies 10AU includes the positive electrode current collectors 14, the positive electrode active material layers 12, the solid electrolyte layers 11A, the negative electrode active material layers 13, and the negative electrode current collector 15. The projecting parts P110A of the solid electrolyte layers 11A that are adjacent between two of the unit electrode bodies 10AU that are adjacent are interconnectedly disposed.

That is, the positive electrode active material layers 12 or the negative electrode active material layers 13 disposed between the solid electrolyte layers 11A that are adjacent between two of the unit electrode bodies 10AU that are adjacent are easily reliably covered by the projecting parts P110A. Because of this, the projecting parts P110A more reliably block electrical contact between the positive electrode active material layers 12 and the negative electrode active material layers 13. In addition, the projecting parts P110A more reliably block electrical contact between the casing 40 and at least one of the positive electrode active material layers 12 or the negative electrode active material layers 13. As a result, in the solid-state battery 1A, the occurrence of short circuits is further inhibited.

As has been described with reference to FIG. 1 to FIG. 7, each of the unit electrode bodies 10AU is configured by laminating the positive electrode current collector 14, the positive electrode active material layer 12, the solid electrolyte layer 11A, the negative electrode active material layer 13, the negative electrode current collector 15, the negative electrode active material layer 13, the solid electrolyte layer 11A, the positive electrode active material layer 12, and the positive electrode current collector 14 in this order along the Z-axis direction. The projecting parts P110A are disposed interconnecting the solid electrolyte layers 11A that are adjacent within the unit electrode bodies 10AU.

That is, the positive electrode active material layers 12 or the negative electrode active material layers 13 disposed between the solid electrolyte layers 11A that are adjacent within the unit electrode bodies 10AU are easily reliably covered by the projecting parts P110A. Because of this, the projecting parts P110A more reliably block electrical contact between the positive electrode active material layers 12 and the negative electrode active material layers 13. In addition, the projecting parts P110A more reliably block electrical contact between the casing 40 and at least one of the positive electrode active material layers 12 or the negative electrode active material layers 13. As a result, in the solid-state battery 1A, the occurrence of short circuits is further inhibited.

As has been described with reference to FIG. 1 to FIG. 7, the projecting parts P110A are disposed so as to cover the end surfaces S12 of the positive electrode active material layers 12 and the end surfaces S13 of the negative electrode active material layers 13.

Because of this, the projecting parts P110A more reliably block electrical contact between the positive electrode active material layers 12 and the negative electrode active material layers 13. The projecting parts P110A more reliably block electrical contact between both the positive electrode active material layers 12 and the negative electrode active material layers 13 and the casing 40. As a result, in the solid-state battery 1A, the occurrence of short circuits is further inhibited.

As has been described with reference to FIG. 1 to FIG. 7, the electrode body 10A has the first side surface portion S10A, the second side surface portion S10B, the third side surface portion S10C, and the fourth side surface portion S10D. The positive electrode current collector tabs 21 project relative to the third side surface portion S10C. The negative electrode current collector tabs 22 project relative to the fourth side surface portion S10D. The projecting parts P110A are disposed so as to cover the first side surface portion S10A and the second side surface portion S10B.

Because of this, the projecting parts P110A reliably block electrical contact between the positive electrode active material layers 12 and the negative electrode active material layers 13 more than in a case where the projecting parts P110A are not disposed so as to cover the first side surface portion S10A and the second side surface portion S10B. The projecting parts P110A more reliably block electrical contact between both the positive electrode active material layers 12 and the negative electrode active material layers 13 and the casing 40. As a result, in the solid-state battery 1A, the occurrence of short circuits is further inhibited.

As has been described with reference to FIG. 1 to FIG. 7, the positive electrode current collector tabs 21 project relative to the third side surface portion S10C. The negative electrode current collector tabs 22 project relative to the fourth side surface portion S10D. The projecting parts P110A are disposed so as to be connected to the positive electrode current collector tabs 21 and the negative electrode current collector tabs 22 at the third side surface portion S10C and the fourth side surface portion S10D.

The positive electrode active material layers 12 or the negative electrode active material layers 13 disposed between the solid electrolyte layers 11A and the positive electrode current collector tabs 21 or the negative electrode current collector tabs 22 are easily reliably covered by the projecting parts P110A. Because of this, the projecting parts P110A more reliably block electrical contact between the positive electrode active material layers 12 and the negative electrode active material layers 13. The projecting parts P110A more reliably block electrical contact between both the positive electrode active material layers 12 and the negative electrode active material layers 13 and the casing 40. As a result, in the solid-state battery 1A, the occurrence of short circuits is inhibited more.

As has been described with reference to FIG. 1 to FIG. 7, the supports 110A in the nonprojecting parts N110 preferably comprise a nonwoven.

As a result, the solid-state battery 1A has a battery performance that is more sufficient than it is in a case where the supports 110A in the nonprojecting parts N110 do not comprise a nonwoven.

As has been described with reference to FIG. 1 to FIG. 7, the manufacturing method of the first embodiment has the preparation step, the unit electrode body formation step, the first heating step, and the second heating step.

The solid-state battery manufacturing method of the first embodiment can manufacture the solid-state battery 1A in which the occurrence of short circuits is inhibited.

### (2) Example Modifications

In the first embodiment, the electrode body 10A includes a plurality of the unit electrode bodies 10AU, but the present disclosure is not limited to this. The electrode body 10A may include one unit electrode body 10AU.

In the first embodiment, each of the unit electrode bodies 10AU is configured by laminating the positive electrode current collector 14, the positive electrode active material layer 12, the solid electrolyte layer 11A, the negative electrode active material layer 13, the negative electrode current collector 15, the negative electrode active material layer 13, the solid electrolyte layer 11A, the positive electrode active material layer 12, and the positive electrode current collector 14 in this order along the Z-axis direction, but the present disclosure is not limited to this. Each of the unit electrode bodies 10AU may also be configured by laminating the positive electrode current collector 14, the positive electrode active material layer 12, the solid electrolyte layer 11A, the negative electrode active material layer 13, and the negative electrode current collector 15 in this order along the Z-axis direction. Each of the unit electrode bodies 10AU may also be configured by laminating the negative electrode current collector 15, the negative electrode active material layer 13, the solid electrolyte layer 11A, the positive electrode active material layer 12, the positive electrode current collector 14, the positive electrode active material layer 12, the solid electrolyte layer 11A, the negative electrode active material layer 13, and the negative electrode current collector 15 in this order along the Z-axis direction. Each of the unit electrode bodies 10AU may further include an insulating layer on the surface of at least one of the positive electrode current collectors 14 on the opposite side of the positive electrode active material layer 12 side.

In the first embodiment, the projecting parts P110A are disposed interconnecting the solid electrolyte layers 11A that are adjacent within the unit electrode bodies 10AU and between two of the unit electrode bodies 10AU that are adjacent, but the present disclosure is not limited to this. In the present disclosure, the projecting parts P110A may be disposed interconnecting the solid electrolyte layers 11A that are adjacent in one of within the unit electrode bodies 10AU and between two of the unit electrode bodies 10AU that are adjacent. The projecting parts P110A may also not be disposed interconnecting the solid electrolyte layers 11A that are adjacent within the unit electrode bodies 10AU and between two of the unit electrode bodies 10AU that are adjacent.

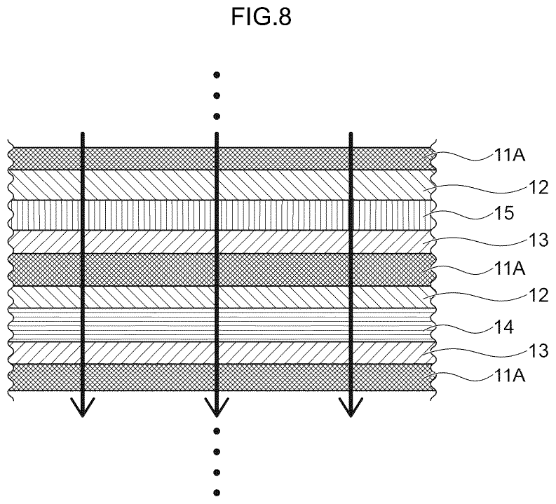

In the first embodiment, the laminate configuration of the electrode body 10A is a configuration where a plurality of the unit electrode bodies 10AU having a monopolar structure are connected in parallel, but the present disclosure is not limited to this. The laminate structure of the electrode body may also be a configuration where a plurality of unit electrode bodies having a monopolar structure are connected in series (hereinafter also called a “monopolar series configuration”). In a monopolar series configuration, the electrode body has a conductor that electrically interconnects the positive electrode current collectors 14 and the negative electrode current collectors 15 and does not have bundles including the plural positive electrode current collector tabs 21 or the plural negative electrode current collector tabs 22. The laminate configuration of the electrode body 10A may also be a configuration where a plurality of unit electrode bodies having a bipolar structure are connected in series. FIG. 8 shows an example of an electrode body having a configuration where a plurality of unit electrode bodies having a bipolar structure are connected in series.

In the first embodiment, the projecting parts P110A are disposed so as to cover the end surfaces S12 of the positive electrode active material layers 12 and the end surfaces S13 of the negative electrode active material layers 13, but the present disclosure is not limited to this. The projecting parts P110A may also not be disposed so as to cover the end surfaces S12 of the positive electrode active material layers 12 and the end surfaces S13 of the negative electrode active material layers 13.

In the first embodiment, the projecting parts P110A are disposed so as to cover the first side surface portion S10A and the second side surface portion S10B, but the present disclosure is not limited to this. The projecting parts P110A may also not be disposed so as to cover the first side surface portion S10A and the second side surface portion S10B.

In the first embodiment, the projecting parts P110A are disposed so as to be connected to the positive electrode current collector tabs 21 and the negative electrode current collector tabs 22 at the third side surface portion S10C and the fourth side surface portion S10D, but the present disclosure is not limited to this. The projecting parts P110A may also not be disposed so as to be connected to the positive electrode current collector tabs 21 and the negative electrode current collector tabs 22 at the third side surface portion S10C and the fourth side surface portion S10D.

In the first embodiment, the casing 40 is a prismatic metal container, but the present disclosure is not limited to this. The casing 40 may also be a container configured by at least one laminate film or may also be a cylindrical metal container.

In the first embodiment, the projecting parts P110A of the supports 110A are formed by melting the projecting parts P110B, but the present disclosure is not limited to this. The projecting parts P110A of the supports 110A may also be formed by welding something corresponding to the projecting parts P110A of the supports 110A to the nonprojecting parts N110 of supports that do not have the projecting parts P110A.

In the first embodiment, the positive electrode current collectors 14 and the positive electrode current collector tabs 21 are separate bodies, and the negative electrode current collectors 15 and the negative electrode current collector tabs 22 are separate bodies, but the present disclosure is not limited to this. The positive electrode current collectors 14 and the positive electrode current collector tabs 21 may also be the same bodies. The negative electrode current collectors 15 and the negative electrode current collector tabs 22 may also be the same bodies.

What is claimed is:

1. A solid-state battery comprising an electrode body and current collector tabs that are connected to the electrode body, wherein:
the electrode body has a positive electrode current collector, a positive electrode active material layer, a solid electrolyte layer, a negative electrode active material layer, and a negative electrode current collector that are laminated along a lamination direction,
the solid electrolyte layer has a support including a plurality of pores,
the support has projecting parts that project relative to end surfaces of each of the positive electrode active material layer and the negative electrode active material layer and a nonprojecting part that is not the projecting parts, and
a number of pores in the support in the projecting parts is less than a number of pores in the support in the nonprojecting part.

2. The solid-state battery of claim 1, wherein:
the electrode body includes a plurality of unit electrode bodies that are laminated along the lamination direction,
each unit electrode body includes the positive electrode current collector, the positive electrode active material layer, the solid electrolyte layer, the negative electrode active material layer, and the negative electrode current collector, and
projecting parts of solid electrolyte layers that are adjacent between two of the unit electrode bodies that are adjacent are interconnectedly disposed.

3. The solid-state battery of claim 2, wherein:
each unit electrode body is configured by laminating the positive electrode current collector, the positive electrode active material layer, the solid electrolyte layer, the negative electrode active material layer, the negative electrode current collector, the negative electrode active material layer, the solid electrolyte layer, the positive electrode active material layer, and the positive electrode current collector in this order along the lamination direction, and
the projecting parts are disposed interconnecting solid electrolyte layers that are adjacent within the unit electrode bodies.

4. The solid-state battery of claim 1, wherein the projecting parts are disposed covering an end surface of at least one of the positive electrode active material layer or the negative electrode active material layer.

5. The solid-state battery of claim 1, wherein:
the electrode body has:
a first side surface portion,
a second side surface portion that opposes the first side surface portion,
a third side surface portion that interjoins the first side surface portion and the second side surface portion, and
a fourth side surface portion that interjoins the first side surface portion and the second side surface portion and opposes the third side surface portion,
the current collector tabs project relative to at least one of the third side surface portion or the fourth side surface portion, and
the projecting parts are disposed covering the first side surface portion and the second side surface portion.

6. The solid-state battery of claim 1, wherein:
the electrode body has:
a first side surface portion,
a second side surface portion that opposes the first side surface portion,
a third side surface portion that interjoins the first side surface portion and the second side surface portion, and
a fourth side surface portion that interjoins the first side surface portion and the second side surface portion and opposes the third side surface portion,
the current collector tabs project relative to at least one of the third side surface portion or the fourth side surface portion, and
the projecting parts are disposed connected to the current collector tabs at the third side surface portion and the fourth side surface portion.

7. The solid-state battery of claim 1, wherein the support in the nonprojecting part comprises a nonwoven.

8. A method of manufacturing a solid-state battery comprising:
preparing a solid electrolyte sheet that has a support including a plurality of pores and a solid electrolyte that is not disposed in projecting parts representing peripheral edge parts of the support but is disposed in a part surrounded by the projecting parts of the support;
laminating a first current collector, a first active material layer, the solid electrolyte sheet, a second active material layer, and a second current collector along a lamination direction to form an electrode body having the projecting parts that project relative to end surfaces of the first active material layer and the second active material layer; and
inputting heat to the projecting parts of the electrode body in a direction from a side surface portion of the electrode body toward an inside of the electrode body to thereby melt the projecting parts at the side surface portion of the electrode body.
